(19) United States
(12) Patent Application Publication
(10) Pub. No.: US 2012/0282477 A1
(43) Pub. Date: Nov. 8, 2012

(54) ASEPTIC PACKAGING

(76) Inventor: Susan M. Ehrhardt, Haddonfield, NJ (US)

(21) Appl. No.: 13/548,695

(22) Filed: Jul. 13, 2012

Related U.S. Application Data
(63) Continuation of application No. 12/508,020, filed on Jul. 23, 2009.

(51) Int. Cl. D21H 17/14; B32B 37/02; B32B 15/12; B65D 81/00; D21H 27/32; B32B 27/10

(52) U.S. Cl. 428/464; 162/179; 162/132; 428/513; 156/281

(57) ABSTRACT

A process to increase the resistance of paper board to hot penetrants using a sizing agent containing fatty acid anhydride, and an insolubilizing agent is disclosed. Additionally a composition useful to impart hot penetrant resistance is disclosed.

### CROSS-REFERENCE TO RELATED APPLICATION

This application is a continuation of U.S. patent application Ser. No. 12/508,020, filed Jul. 23, 2009.

### TECHNICAL FIELD

The present invention relates to a method for sizing paperboard to provide resistance to hot penetrants. This method can be used for aseptic packaging board to provide resistance to both the hot hydrogen peroxide solution that is used to sterilize the package as well as the liquid that is to be packaged in the container.

### BACKGROUND OF INVENTION

For some time liquid products, and in particular liquid dairy products such as milk and cream, have been packaged in containers made of coated paperboard. This board, known in the industry as liquid packaging board, is typically coated on both sides with polyethylene.

To be functional in this application, the board must be resistant to the effects of the liquid. For liquid dairy products, the most aggressive component of the liquid is generally lactic acid. The most vulnerable portion of the board is usually the cut edge. It is known that board sized with AKD (alkyl ketene dimer) has good resistance to edge penetration by lactic acid-containing liquids.

In recent years there has been a trend toward aseptic packaging of consumable liquids. Aseptic containers are formed from a composite structure consisting of coated or uncoated paperboard, polyethylene and aluminum foil. The board is sterilized before filling by passing through a hydrogen peroxide solution at elevated temperature.

Therefore this board must resist not only the liquid that will ultimately be packaged in the container, but the hot hydrogen peroxide solution used to sterilize the container as well. The AKD based sizing agents that are known to provide superior resistance to edge penetration by lactic acid containing liquids were found to be only moderately effective against hot hydrogen peroxide solutions (see for example U.S. Pat. No. 4,927,496, U.S. Pat. No. 5,308,441, U.S. Pat. No. 5,456,800, U.S. Pat. No. 5,626,719). Rosin based sizing agents have been demonstrated to provide the needed resistance to hot hydrogen peroxide solutions, but are not as effective against the acidic materials packaged in these containers (see for example U.S. Pat. No. 4,927,496, U.S. Pat. No. 5,308,441, U.S. Pat. No. 5,456,800, U.S. Pat. No. 5,626,719)).

As a consequence, a dual sizing system is used for aseptic packaging grades. Both AKD and rosin are used to provide sizing in aseptic packaging, either with both sizing agents added internally (U.S. Pat. No. 4,927,496) or with one used internally and the other added on the surface (U.S. Pat. No. 5,308,441). Unfortunately the optimum pH for rosin sizing efficiency, about pH 5, is lower than the optimum pH for AKD sizing efficiency, about pH 7.5. Therefore, the system is run at a compromise pH for both sizing agents, about 6.5, resulting in less than optimal performance (U.S. Pat. No. 7,291,246). Additionally, the system is cumbersome since typically two sizing agents must be inventoried and metered into the papermaking system.

Previous attempts to address these shortcomings include the use of a combination of cellulose reactive and non-reactive sizing agents with thermosetting resins (U.S. Pat. No. 5,456,800, U.S. Pat. No. 5,626,719) and the use of catalase or manganese ore to decompose the hydrogen peroxide to form oxygen gas that forms a protective gas layer which prevents penetration of the paperboard (U.S. Pat. No. 7,291,246).

U.S. Pat. Nos. 4,859,244 and 3,311,532 disclose paper sizing agents composed of blends of fatty acid anhydrides and alkyl ketene dimers that provide improved sizing. However, neither discusses the problem caused by sterilization by hot hydrogen peroxide, nor is there any indication that the sizing agents disclosed would have any effect on resistance to edge penetration by hot hydrogen peroxide or other hot penetrants. Additionally, U.S. Pat. No. 4,859,244 teaches that “the sizing quality is substantially unaffected by the presence of alum”, providing data that demonstrates equal performance with and without alum in the system.

### BRIEF SUMMARY OF THE INVENTION

The present invention addresses the shortcomings of the use of a dual sizing system to achieve the sizing requirements of aseptic packaging board, resistance to hot hydrogen peroxide and resistance to lactic acid. It has been discovered that use of fatty acid anhydride alone or in combination with AKD, both reactive sizing agents, along with an insolubilizing agent provides resistance to both lactic acid containing liquids and hot hydrogen peroxide solutions superior to either ketene dimer alone or the dual sizing system of ketene dimer and rosin. A reactive sizing agent is one that chemically reacts with cellulose.

The present invention provides a process to increase the resistance of paper board to penetration by hot penetrants, the process comprises a) adding i) an aqueous emulsion, comprising a reactive sizing agent and ii) an insolubilizing agent, either separately or in blended form to an aqueous pulp slurry, wherein the reactive sizing agent comprises at least 30% by weight fatty acid anhydride and b) forming the slurry into paper or paperboard.

### DETAILED DESCRIPTION OF THE INVENTION

It has been found that if fatty acid anhydride or a blend of fatty acid anhydride and ketene dimer are added, together with an insolubilizing agent to a pulp slurry at a near neutral pH (for example, pH 6.0 to 7.5, preferably 6.5 to 7.5, or preferably 6.7 to 7.3) and the pulp is then formed into board, the board has good resistance to edge penetration by both hot hydrogen peroxide and lactic acid solutions.

Moreover, it has been found that the resistance of the board to hot hydrogen peroxide is unexpectedly better when a blend of fatty acid anhydride and ketene dimer are used than would be predicted by adding together the effects of the two sizes when used alone.

The reactive sizing agents useful in this invention can be emulsified separately and added separately to the pulp slurry, emulsified separately then mixed together at the addition point before addition to the pulp slurry or blended before emulsification.

Any of the ketene dimers known in the art may be used in the process of the present invention. Ketene dimers used as sizing agents are dimers having the formula:

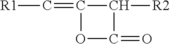

wherein R1 and R2 are alkyl radicals, which may be saturated or unsaturated, having from 6 to 24 carbon atoms, preferably more than 10 carbon atoms and most preferably from 14 to 16 carbon atoms. R1 and R2 can be the same or different. These ketene dimers are well known, for example from U.S. Pat. No. 2,785,067, the disclosure of which is incorporated herein by reference.

Suitable ketene dimers include decyl, dodecyl, tetradecyl, hexadecyl, octadecyl, eicosyl, docosyl, tetracosyl ketene dimers, as well as ketene dimers prepared from palmitoleic acid, oleic acid, ricinoleic acid, linoleic acid, myristoleic acid and eleostearic acid. The ketene dimer may be a single species or may contain a mixture of species. The most preferred ketene dimers are alkyl ketene dimers prepared from C14-C22 linear saturated fatty acids.

Acid anhydrides used as sizing agents can be characterized by the general formula:

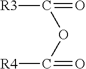

wherein R3 and R4 are alkyl radicals, which may be saturated or unsaturated, having from 6 to 24 carbon atoms, preferably more than 10 carbon atoms and most preferably from 14 to 16 carbon atoms. R3 and R4 can be the same or different. The most preferred acid anhydrides are acid anhydrides prepared from C14-C22 linear saturated fatty acids.

Any of the methods known for the preparation of dispersions of ketene dimer can be used to emulsify the acid anhydride and the ketene dimer. Frequently, the AKD is combined with dispersant systems which include cationic starch and sodium lignosulfonate. Examples of such dispersions can be found in U.S. Pat. No. 4,861,376 to Edwards, and U.S. Pat. No. 3,223,544 to Savina, the disclosures of which are hereby incorporated for reference. Alternatively, the acid anhydride and ketene dimer can be emulsified in-mill using any of the known methods.

These emulsions may include other additives common to size emulsions, for example, promoter resins for ketene dimers, biocides, antifoams, etc. The solids in the emulsions may vary from about 2 to about 50% by weight, preferably from about 4 to 40% and most preferably from about 5 to 35%.

The ketene dimer and fatty acid anhydride can be emulsified separately and added separately to the papermaking system, or the emulsions may be mixed together before addition. Alternatively the acid anhydride and ketene dimer can be blended before emulsification. The fatty acid anhydride and ketene dimer can be manufactured as a blend or they can be manufactured separately.

Fatty acid anhydrides react with cellulose to form an ester and a molecule of free fatty acid. The free fatty acid can react with the insolubilizing agent to form an insoluble salt. It is this insoluble salt that is believed to provide the enhanced resistance to hot penetrants.

The insolubilizing agent may be any one of those known in the art, such as papermaker's alum (aluminum sulfate), polyaluminum chloride (PAC) or other polyaluminum compounds, and is preferably alum. The amount of alum to be used is determined based on the type of pulp, the amount of sizing agent being applied, and other factors well known to those skilled in the art (e.g., system alkalinity, level of anionic “trash”, etc.). Generally, the amount of insolubilizing agent will be from about 5 to 15 lb/T (0.25 to 0.75% based on dry weight of fiber).

The insolubilizing agent may be added at the same addition point as the sizing agent, or the feed may be split so that some is added early in the system to neutralize anionic materials with the rest being added with the sizing agent.

Fatty acid anhydride can be used alone or in combination with alkyl ketene dimer. If used in combination with alkyl ketene dimer, the blend must contain at least 30% fatty acid anhydride. In the preferred blend, 40-70% of the reactive sizing material is fatty acid anhydride.

The sizing agents of this invention can be applied as internal sizing agents or surface sizing agents. Internal sizing involves adding the size to the paper pulp slurry before sheet formation, while surface sizing involves immersion of the paper in a solution containing the sizing agent, followed by drying at elevated temperatures in accordance with known drying techniques. Internal sizing is preferred.

The present invention is useful in sizing paper materials such as, for example, aseptic packaging board. The amount used is based on the desired sizing requirements of the customer, depending upon the required degree of sizing, the grade of paper, the type of pulp furnish used to make the paper, and other factors well known and easily determined empirically by those skilled in the art. In general, the least amount of sizing agent is used to obtain the desired sizing specifications. Typically, the amount of sizing agent will be from 4 to 10 lb/T (0.2 to 0.5% based on dry weight of fiber).

The pulp slurry may be processed in any conventional manner, for instance into board for aseptic packaging use, and any other conventional additives, such as retention aids, strength additives, pigments or fillers, may be added as desired.

The present invention also includes products, such as boards, made from pulp treated by the process of the present invention.

In addition to providing good resistance to hot hydrogen peroxide the compositions of this invention provide good resistance to other hot penetrants (i.e., penetrants above about 40° C.) commonly encountered in the industry, for example boiling water, hot coffee and hot coffee with cream, tests commonly used for testing cupstock (i.e., paperboard used in the production of drink cups).

### EXAMPLES

The following examples are given for the purpose of illustrating the present invention. All parts and percentages are by weight unless otherwise indicated.

In the following examples, evaluations were made using a pilot scale papermachine designed to simulate a commercial Fourdrinier, including stock preparation, refining and storage. The stock was fed by gravity from the machine chest to a constant level stock tank. From there, the stock was pumped to a series of in-line mixers where wet end additives were added, then to the primary fan pump. The stock was diluted with white water at the fan pump to about 0.20 solids. Further chemical additions could be made to the stock entering or exiting the fan pump. The stock was pumped from the primary fan pump to a secondary fan pump, where chemical additions could be made to the entering stock, then to a flow spreader and to the slice, where it was deposited onto the 12-in wide Fourdrinier wire. Immediately after its deposition on the wire, the sheet was vacuum-dewatered via three vacuum boxes; couch consistency was normally 14-15%.

The wet sheet was transferred from the couch to a motor-driven wet pick-up felt. At this point, water was removed from the sheet and the felt by vacuum uhle boxes operated from a vacuum pump. The sheet was further dewatered in a single-felted press and left the press section at 38-40% solids.

In the following examples, evaluations were made using a blend of bleached hardwood kraft (70%) and bleached softwood kraft (30%) with a Canadian standard freeness of 350-400 cc. The water for dilutions was adjusted to contain 50 ppm hardness and 120 ppm alkalinity. Addition levels for all additives are given in percent based on dry weight of fiber. The addition of 0.95% quaternary-amine substituted cationic starch (Sta-Lok® 400, A. E. Staley, Decatur, Ill.) was split between the stock pump and the fan pump outlet. Alum and size were added in the amounts indicated in the examples at the fan pump inlet. PerForm® PM9025, an inorganic microparticle retention aid (Hercules Incorporated, Wilmington, Del.) was added at 0.038% at the secondary FP. Stock temperature was maintained at 55° C. The headbox pH was controlled to 6.8 unless otherwise indicated.

A 244 g/sq m (150 lb/3000 ft2 ream) sheet was formed and dried on seven dryer cans to 5% moisture (dryer can surface temperatures increased from 65 to 110° C.) and passed through a single nip of a 5-nip, 6 roll calendar stack at 28 pli. Edgewick resistance was measured on board naturally aged in a CT room (50% RH, 25° C.).

Edgewick tests are standard tests in the liquid packaging industry for measuring the degree of sizing. For this test, samples of board are laminated on both sides using a self-adhesive tape. Coupons of a given size are cut from the laminated board, weighed, and then immersed in the test solution at the designated temperature. After the specified time the samples are removed from the test solution, dried by blotting and reweighed. The results are reported as kg of solution absorbed per sq meter of exposed edge (kg/sq m). Low edgewick values are better than high values. The amount of sizing desired depends upon the grade of board being made.

The test solutions used were:
Hot hydrogen peroxide: 35% hydrogen peroxide at 70° C.; 10 min soak
Lactic Acid: 20% lactic acid at 25° C.; 30 min soak

### Example 1

### Superior Resistance to Hot Hydrogen Peroxide

Emulsions of Aquapel® 364 alkyl ketene dimer (Hercules Incorporated, Wilmington, Del.) and stearic anhydride (99% Aldrich), stabilized with cationic starch were prepared by known methods (see, for example, U.S. Pat. No. 3,223,544, U.S. Pat. No. 4,861,376) and evaluated on the pilot papermachine as described above. The control was a binary sizing system comprised of Hi-pHase® 35 cationic dispersed rosin size (Hercules Incorporated, Wilmington, Del.) and the emulsion of Aquapel® 364.

In this evaluation 0.375% alum was used as the insolubilizing agent. The SA/AKD blend was made by adding the stearic anhydride emulsion and the AKD emulsion through a mixing T at a 60/40 ratio (based on actives) to reach the target level of sizing agent (e.g., for 0.10% sizing agent, 0.06% stearic anhydride and 0.04% AKD emulsions (based on actives) were added).

TABLE 1

| | Hot Hydrogen Peroxide Wicks, kg/sq m | | | |
|---|---|---|---|---|
| | Control: | AKD | Stearic | |
| Size | Rosin/AKD | 0.05% | Anhydride | SA/AKD |
| Addition Levels | 0.375% alum | alum | 0.375% alum | 0.375% alum |
| Control: 0.21% | 0.9 | | | |
| Rosin/0.12% AKD | | | | |
| 0.10% | | 4.31 | 2.64 | 2.34 |
| 0.20% | | 1.47 | 0.89 | 0.74 |
| 0.30% | | | 0.65 | 0.63 |

This example demonstrates that stearic anhydride provides better resistance to hot hydrogen peroxide than the binary sizing system (control) at similar addition levels (pick up of only 0.65 kg/sq m at 0.3% hydrophobe with SA vs. 0_{—}9 with 0.33% hydrophobe with the binary system). Alternatively, stearic anhydride provided similar resistance to hot hydrogen peroxide as the binary sizing system (control) at reduced levels of hydrophobe (only 0.2% of the stearic anhydride was needed to achieve a hot hydrogen peroxide wick of 0.89 kg/sq m vs. 0.33% hydrophobe required to achieve that level of resistance for the binary system).

Surprisingly the blend of stearic anhydride and AKD provided better resistance to hot hydrogen peroxide than either sizing agent alone, at equal levels of hydrophobe: 0.2% SA/AKD (i.e., 0.12% of the SA and 0.08% of the AKD emulsions) resulted in a hot hydrogen peroxide wick of 0.74 kg/sq m whereas 0.2% SA gave 0.89 and 0.2% AKD gave 1.47.

### Example 2

### Superior Resistance to Lactic Acid

The board produced in Example 1 was also evaluated for resistance to lactic acid. Though not as effective as AKD, the blend of stearic anhydride and AKD also provides superior resistance to lactic acid compared to the binary control sizing system:

TABLE 2

| | 20% Lactic Acid Wicks, kg/sq m | | | |
|---|---|---|---|---|
| | Control: | AKD | Stearic | |
| Size | Rosin/AKD | 0.05% | Anhydride | SA/AKD |
| Addition Levels | 0.375% alum | alum | 0.375% alum | 0.375% alum |
| Control: 0.21% | 0.54 | | | |
| rosin/0.12% AKD | | | | |
| 0.10% | | 1.12 | 21.66 | 12.59 |
| 0.20% | | 0.39 | 1.14 | 0.42 |
| 0.30% | | | 0.48 | 0.21 |

To work as an effective system for an aseptic packaging application both lactic acid resistance and hot hydrogen peroxide resistance is needed.

### Example 3

### Effect of pH

Board was prepared as described in Example 1, varying the headbox pH from 6.5 to 7.5, and using 0.375 wt. percent alum as the insolubilizing agent. The ratio of SA to AKD was 60:40. A near neutral, slightly acidic pH gave the best resistance to hot hydrogen peroxide:

TABLE 3

| | Hot Hydrogen Peroxide Wicks kg/sq m | | |
|---|---|---|---|
| pH | 0.1% SA/AKD | 0.2% SA/AKD | 0.3% SA/AKD |
| 6.5 | 1.84 | 0.76 | 0.46 |
| 7 | 2.99 | 0.79 | 0.48 |
| 7.5 | 5.65 | 1.17 | 0.57 |

TABLE 4

| | 20% Lactic Acid Wicks, kg/sq m | | |
|---|---|---|---|
| pH | 0.1% SA/AKD | 0.2% SA/AKD | 0.3% SA/AKD |
| 6.5 | 13.90 | 0.43 | 0.31 |
| 7 | 13.76 | 0.36 | 0.32 |
| 7.5 | 15.03 | 0.40 | 0.22 |

### Example 4

### Resistance to Other Hot Penetrants

Board was prepared as described in Example 1. The ratio of SA to AKD was 60:40. Board was tested for resistance to boiling water (boiling boat test: time for boiling water to penetrate through the z-direction of the board), Dixie Cobb (standard Cobb test run with hot water) and hot coffee and hot coffee with creamer Cobbs (see Tappi Test Method T 441om-04 for a description of the Cobb test).

TABLE 5

| | Dixie Cobb (82 C. (180 F.) water, 2 min soak), g/sq m | | | |
|---|---|---|---|---|
| | Control: 0.21% | | Stearic | |
| | rosin/0.12% AKD | AKD | Anhydride | SA/AKD |
| | 0.5% alum | 0.05% alum | 0.5% alum | 0.5% alum |
| 0.21% rosin/ | 32 | | | |
| 0.12% AKD | | | | |
| 0.20% | | 38 | 34 | 35 |
| 0.30% | | 35 | 32 | 34 |

TABLE 6

| | Coffee Cobb (82 C. (180 F.) | | | |
|---|---|---|---|---|
| | Maxwell house coffee, 2 min soak) | | | |
| | Control: 0.21% | | Stearic | |
| | rosin/0.12% AKD | AKD | Anhydride | SA/AKD |
| | 0.5% alum | 0.05% alum | 0.5% alum | 0.5% alum |
| 0.21% rosin/ | 44 | | | |
| 0.12% AKD | | | | |
| 0.20% | | | 41 | 55 |
| 0.30% | | 46 | 38 | 44 |

TABLE 7

| | Coffee with creamer (82 C. (180 F.) Maxwell | | | |
|---|---|---|---|---|
| | House coffee with Domino creamer, 2 min soak) | | | |
| | Control: 0.21% | | Stearic | |
| | rosin/0.12% AKD | AKD | Anhydride | SA/AKD |
| | 0.5% alum | 0.05% alum | 0.5% alum | 0.5% alum |
| 0.21% rosin/ | 50 | | | |
| 0.12% AKD | | | | |
| 0.20% | | 51 | 46 | 50 |
| 0.30% | | 48 | 43 | 45 |

The boiling boat results for all of the above samples were 2000+ seconds.

The results showed that the inventive process provides resistance to other hot penetrants.

### Example 5

### Increasing Alum Addition Level

Board was prepared as described in Example 1, varying the alum addition level from 0.0 to 0.75%, maintaining headbox pH at 6.5. Clearly, resistance to hot hydrogen peroxide improved as the level of insolubilizing agent was increased.

TABLE 8

| | Hot Hydrogen | | |
|---|---|---|---|
| | Peroxide Wicks, kg/sq m | | |
| | 0.1% | 0.2% | 0.3% |
| Alum level | SA/AKD | SA/AKD | SA/AKD |
| 0 | 7.27 | 2.42 | 1.02 |
| 0.375 | 1.84 | 0.76 | 0.43 |
| 0.75 | 1.76 | 0.66 | 0.38 |

For reference, the control system with 0.21% rosin, 0.12% AKD and 0.375% alum had a hot hydrogen peroxide wick of 0.50 kg/sq m.

### Example 6

### Varying the Fatty Acid Anhydride to Alkyl Ketene Dimer Ratio

Board was prepared as described in Example 1 except the ratio of stearic anhydride to Aquapel 364 was varied. There was a general trend toward improved resistance to hot hydrogen peroxide with increased levels of stearic anhydride in the blend.

TABLE 9

| | Hot Hydrogen Peroxide Wicks, kg/sq m | | | |
|---|---|---|---|---|
| Size | | | | 60 SA/40 |
| Addn Level, % | Control | 40 SA/60 AKD | 50 SA/50 AKD | AKD |
| 0.21% rosin + | 1.88 | | | |
| 0.12% AKD | | | | |
| 0.2 | | 2.08 | 2.06 | 1.60 |
| 0.3 | | 1.30 | 0.89 | 1.03 |

1. An aseptic package, comprising:
at least one layer of paperboard providing resistance to hot penetrants, wherein the at least one layer is prepared by a process comprising a) adding i) an aqueous emulsion, comprising a reactive sizing agent and ii) an insolubilizing agent, either separately or in blended form to an aqueous pulp slurry, and wherein the reactive sizing agent comprises at least 30% fatty acid anhydride, and b) forming the slurry into paperboard, wherein the insolubilizing agent is selected from the group consisting of alum (aluminum sulfate), polyaluminum chloride (PAC) and other polyaluminum compounds.

2. The aseptic package of claim 1, wherein the pH of the pulp slurry in the process for preparing the at least one layer of paperboard is from about 6.5 to 7.5.

3. The aseptic package of claim 1, wherein the pH of the pulp slurry in the process for preparing the at least one layer of paperboard is from about 6.7 to 7.3.

4. The aseptic package of claim 1, wherein the reactive sizing agent in the process for preparing the at least one layer of paperboard comprises from 40 to 70% fatty acid anhydride.

5. The aseptic package of claim 1, wherein the fatty acid anhydride in the process for preparing the at least one layer of paperboard is prepared from C14 to C22 linear saturated fatty acids.

6. The aseptic package of claim 1, wherein the insolubilizing agent in the process for preparing the at least one layer of paperboard is alum.

7. The aseptic package of claim 1, wherein the insolubilizing agent in the process for preparing the at least one layer of paperboard is added to the pulp slurry in an amount of from about 5 to about 15 lbs insolubilizing agent per ton of dry pulp.

10. The aseptic package of claim 1, wherein the sizing agent in the process for preparing the at least one layer of paperboard further comprises an alkyl ketene dimer.

11. The aseptic package of claim 9 wherein the alkyl ketene dimer is prepared from C14 to C22 linear saturated fatty acids.

12. The aseptic package of claim 1, further comprising at least one other layer selected from the group consisting of polyethylene and aluminum foil.

13. The aseptic package of claim 1, wherein the at least one layer of paperboard is uncoated.

14. A method for making an aseptic package, comprising:
preparing a paperboard by adding i) an aqueous emulsion, comprising a reactive sizing agent and ii) an insolubilizing agent, either separately or in blended form to an aqueous pulp slurry, wherein the pulp slurry is at a pH of 6.5 to 7.5, wherein the reactive sizing agent comprises at least 30% fatty acid anhydride, wherein the insolubilizing agent is selected from the group consisting of: alum, (aluminum sulfate), polyaluminum chloride (PAC) and other polyaluminum compounds; and
forming the slurry into a paperboard;
combining the paperboard with at least one other layer to form the aseptic package.

15. The method of claim 13, wherein the at least one other layer is selected from the group consisting of polyethylene and aluminum foil.

16. The method of claim 13, wherein a plurality of paperboard layers are combined with the at least one other layer to form the aseptic package.

17. The method of claim 13, further comprising sterilizing the aseptic package with one or more hot penetrants.

18. An aseptic package, comprising:
at least one layer of paperboard comprising (a) fatty acid anhydride optionally comprising an alkyl ketene dimer, the weight ratio of the alkyl ketene dimer to fatty acid anhydride less than 2 to 1, and (b) an insolubilizing agent selected from the group consisting of alum (aluminum sulfate), polyaluminum chloride (PAC) and other polyaluminum compounds.

19. The aseptic package of claim 17, wherein the insolubilizing agent in the paperboard is alum.

20. The aseptic package of claim 17, comprising two or more layers of paperboard.

21. The aseptic package of claim 17, further comprising at least one other layer selected from the group consisting of: polyethylene and aluminum foil.

22. The aseptic package of claim 17, wherein the paperboard is resistant to penetration of hot hydrogen peroxide.
